(19) United States
(12) Patent Application Publication
(10) Pub. No.: US 2025/0128347 A1
(43) Pub. Date: Apr. 24, 2025

(54) METHODOLOGY TO MANUFACTURE A MONOLITHIC VESSEL HEAD WITH INTEGRAL TUBE ATTACHMENTS VIA SOLID-STATE JOINING

(71) Applicant: Electric Power Research Institute, Inc., Charlotte, NC (US)

(72) Inventors: David W. Gandy, Hampstead, NC (US); Steven Jones, Sheffield (GB); William J. Kyffin, Sheffield (GB)

(21) Appl. No.: 18/490,894

(22) Filed: Oct. 20, 2023

(51) Int. Cl. B23K 20/12; B23K 101/12; B23K 103/20

(52) U.S. Cl. CPC B23K 20/129; B23K 2101/12; B23K 2103/20

(57) ABSTRACT

A method of manufacturing a monolithic vessel head with integral tube attachments is disclosed. The method includes the steps of forging a vessel head; boring at least one penetration in the vessel head; and inserting a tube into the at least penetration and using a solid-state joining process to join the tube to the vessel head.

### BACKGROUND OF THE INVENTION

This invention relates generally to the manufacture of a monolithic vessel head, and more particularly to a method of manufacturing a monolithic reactor pressure vessel head using a solid-state welding process.

The manufacture and production of reactor pressure vessel (RPV) heads (domes) is an extremely complex process that is costly and requires months and months of time, expertise and labor to meet rigorous industry nuclear standards, quality, and component tolerances. RPV heads 10, illustrated in FIG. 1, are conventionally forged from low alloy RPV steels, such as SA508 steel, and then bored to accept penetrations and the attachment of multiple control rod drive tubes 12, instrumentation tubes, and inspection nozzles.

For decades manufacturers of reactors have employed a multi-stage approach to the production of RPV heads. The approach involves the use of heavy forging or hot working operations to generate the reactor head dome followed by heat treatment; machining/boring of tube penetrations; the use of highly skilled gas tungsten arc welding (GTAW) craft or equipment to attach the control rod drive (CRD) tubes, instrumentation tubes, and/or inspection nozzles; and extensive non-destructive examination (NDE) of the completed weld and weld penetration region.

This approach not only results in considerable effort during manufacturing to assure that the weld region is acceptable but also requires expensive in-service inspections (ISI) at future intervals (e.g., every 10 years) once the nuclear unit is commissioned and under operation. Furthermore, the weld between the RPV head and tubes (e.g., CRD tubes, instrumentation tubes, and/or inspection nozzles) include the SA508 low alloy steel RPV head base metal attached to an austenitic stainless-steel tube resulting in a dissimilar metal weld (DMW). Examples of austenitic stainless-steel include 304L and 316L stainless steels.

The dissimilar metal welds (DMWs) that join tubing to the RPV head are not only complex and difficult to produce during original manufacturing, but they are also extremely expensive to inspect once in-service. Furthermore, once in service, if a reactor owner determines that damage exists in a reactor head-to-tube weld, the owner may be faced with the option of a costly repair or replacement of the entire reactor head. A J-prep weld design is commonly used for the attachment weld. The welds may be performed on both the inside and/or outside of the vessel head; however, the J-prep welds can be very difficult to machine and weld due to factors such as confined spaces and the fact that the J-prep welds are non-symmetrical, as shown in FIG. 2.

As a result, utilities have insisted that manufacturers develop and/or demonstrate new methodologies for manufacturing the RPV heads that eliminate the DMW altogether and produce the entire head and tubes as one monolithic structure (i.e., a vessel head with integral tube attachments).

### BRIEF SUMMARY OF THE INVENTION

This invention addresses the problem of DMWs in vessel heads and tube attachments by using a solid-state joining method to integrally join tubing and/or nozzles to a vessel head to produce a single, monolithic component without DMWs.

According to one aspect of the technology described herein, a method of manufacturing a monolithic vessel head includes the steps of forging a vessel head; boring at least one penetration in the vessel head; and inserting a tube into the at least penetration and using a solid-state joining process to join the tube to the vessel head.

According to another aspect of the technology described herein, a method of manufacturing a monolithic vessel head includes the steps of forging a vessel head; performing heat treatment on the vessel head; boring at least one penetration in the vessel head; counterboring the at least one penetration; calculating forces necessary to insert a tube into the at least one penetration; and inserting a tube into the at least penetration and using a solid-state joining process to join the tube to the vessel head.

### BRIEF DESCRIPTION OF THE DRAWINGS

The invention may be best understood by reference to the following description taken in conjunction with the accompanying drawing figures in which:

FIG. 1 shows a vessel head with penetrations;

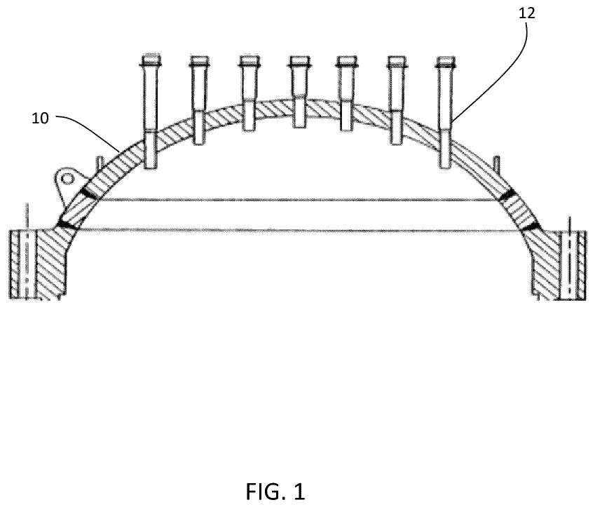

FIG. 2 illustrates a J-prep weld;

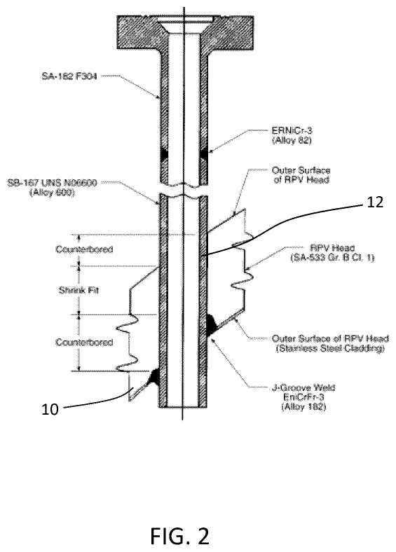

FIG. 3 illustrates a method of manufacturing the vessel head of FIG. 1;

FIG. 4 illustrates a friction hydropillar process for use in the method of FIG. 3;

FIG. 5 illustrates a method of manufacturing the vessel head of FIG. 1;

FIG. 6 illustrates an induction preheating method for the method of FIG. 5; and

FIG. 7 illustrates a method of manufacturing the vessel head of FIG. 1.

### DETAILED DESCRIPTION OF THE INVENTION

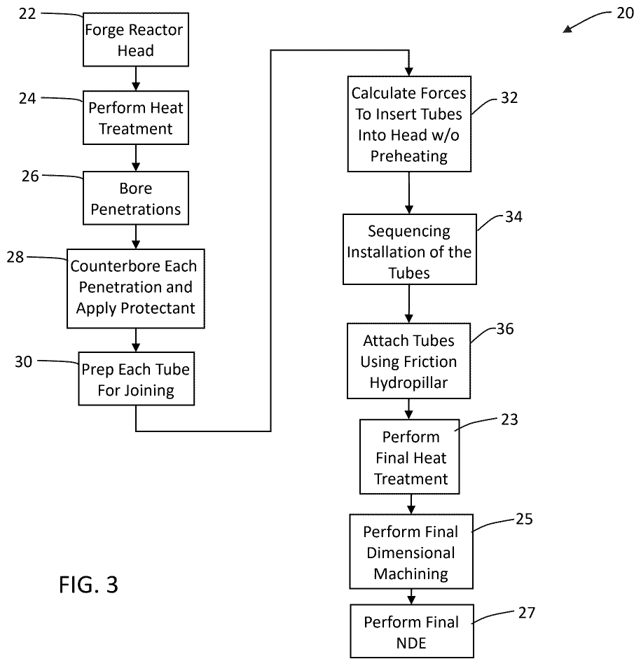

Referring to the drawings wherein identical reference numerals denote the same elements throughout the various views, FIG. 3 illustrates a method 20 according to a first embodiment for eliminating DMWs and creating a single monolithic RPV head with tubing and/or nozzles integrally joined to the RPV head during manufacturing. Such tubing and/or nozzles includes CRD tubes, inspection tubes, and inspection nozzles, as well as any other suitable tubing and/or nozzles. It should be appreciated that while the method is being described with respect to nuclear applications, applicability of the method may be used across any industry that utilizes vessels. Such industries include petrochemical, pulp and paper, fossil power generation (including heat recovery steam generators), food processing, pharmaceutical, and off-shore oil and gas to name a few.

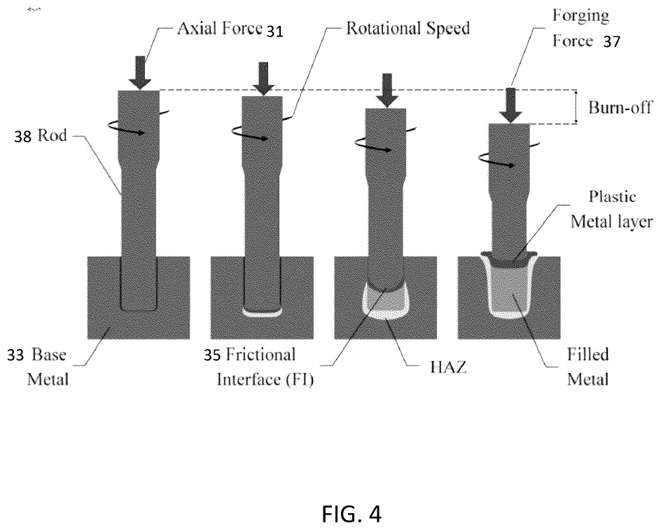

The method 20 uses a solid-state joining method to integrally attach low alloy steel tubes to an RPV head. The solid-state process would include the following steps:
1. Forge a reactor head (22) using conventional hot working methodologies similar to those already employed by forging companies today to produce the head, minus the tubes. This essentially results in a dome without penetrations or tubes at this point in the process.
2. Perform heat treatment (24) of the vessel head.
3. Bore the penetrations (26) to accept each of the tubing and/or nozzles (e.g., CRD tubes, inspection tubes, and inspection nozzles) to neat net shape (NNS). Note, this requires precise alignment for each penetration.
4. Counterbore each penetration (28) to accept a tube and/or nozzle and protect the counterbore region with an appropriate protectant to minimize oxidation of the counterbored region. One example of a protectant is COSMOLINE.
5. Prep each tube (30) for joining and protect with an appropriate protectant to minimize oxidation of the tube.
6. Calculate forces (32) necessary to insert tubes (or solid) into the counterbored region(s) of the vessel head using no preheating of the vessel. Forces include but are not limited to downward axial and rotational forces.
7. Attach individual tubes (36) (or solid) using friction hydropillar equipment/methodology, as shown in FIG. 4. Due to the size of the equipment and the close proximity of tubes, one will need to determine the proper sequencing (34) of tubes to assure that all tubes can be joined using this methodology. One such example of sequencing is: installation of one half of the tubes (or solid) at one length in an alternating sequence, followed by installation of the second half of the tubes (or solids) at a slightly longer length to avoid interference with the first set of tubes.
8. Perform final heat treatment (23) which includes a solution anneal, normalization, and temper to achieve properties.
9. Perform final dimensional machining (25).
10. Perform final NDE (27) of the component including all joined regions between the vessel head and the tubes.

As shown in FIG. 4, friction hydropillar equipment applies an axial force 31 as the rod or tube 38 is rotated. As shown, heat begins to form at the frictional interface between the rod 38 and base metal 33. As the process continues, the heat affected zone (HAZ) 35 increases in size. The HAZ is the area between the joint and the base metal 33. A forging force 37 is applied, bonding the tube 38 and base metal 33 together. This results in the tube 38 being integrally joined with the vessel head 22.

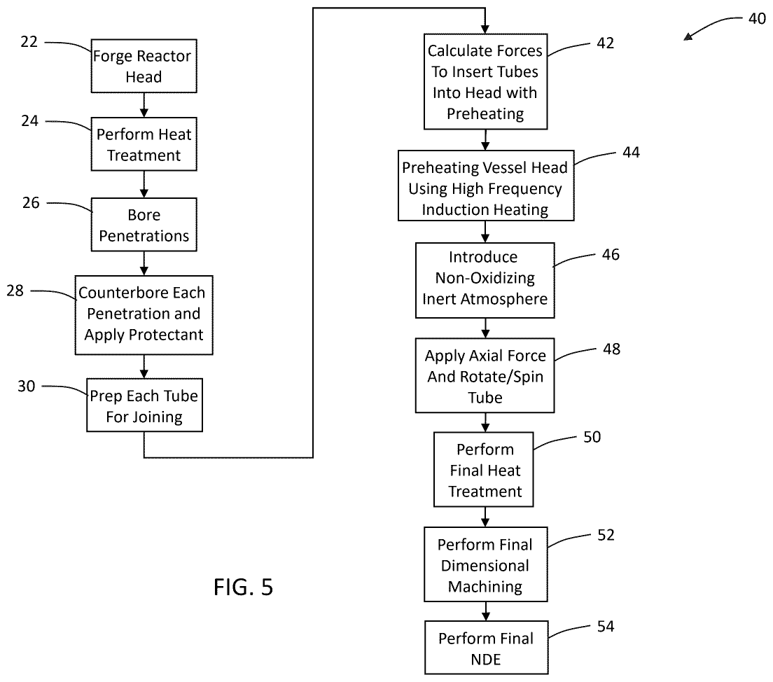

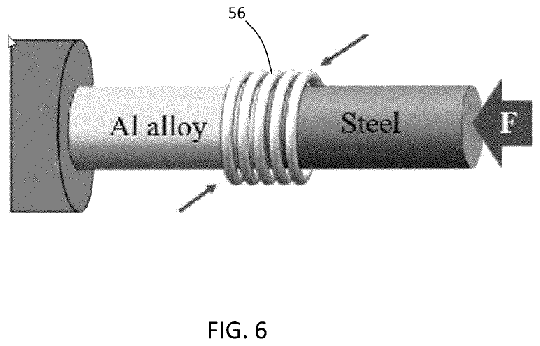

Referring to FIG. 5, a method 40 of solid-state joining is shown. Method 40 uses an induction heating, FIG. 6, method which preheats the vessel region where a tube is to be attached to fifty to ninety percent (50-90%) of a working temperature range and then integrally joins the tube to the vessel head using solid-state joining. Like method 20, method 40 utilizes the steps of:
1. Forge a reactor head (22) using conventional hot working methodologies similar to those already employed by forging companies today to produce the head, minus the tubes. This essentially results in a dome without penetrations or tubes at this point in the process.
2. Perform heat treatment (24) of the vessel head.
3. Bore the penetrations (26) to accept each of the tubing and/or nozzles (e.g., CRD tubes, inspection tubes, and inspection nozzles) to neat net shape (NNS). Note, this requires precise alignment for each penetration.
4. Counterbore each penetration (28) to accept a tube and/or nozzle and protect the counterbore region with an appropriate protectant to minimize oxidation of the counterbored region. One example of a protectant is COSMOLINE.
5. Prep each tube (30) for joining and protect with an appropriate protectant to minimize oxidation of the tube.

Method 40 further utilizes the steps of:
6. Calculate forces (42) necessary to insert tubes (or solid) into vessel head using preheating methods. Forces include but are not limited to downward axial and rotational forces. According to U.S. Pat. No. 6,637,642 conventional friction welding of carbon or low alloy steel tubular components requires a kinetic energy input range in between 20000 to 100,000 ft-lbs/inch² for medium to large size workpieces having a diameter of ˜4.0 inches, whereas a solid state joining method wherein the components are heated into the hot working range may require only 1/10th of the kinetic energy to achieve the same bonding force.
7. Preheating (44) should be accomplished with high frequency induction heating (or other viable means) to promote a thin layer of preheated base material sufficient to join a tube (or solid) via a solid-state joining method. As used herein, high frequency induction heating refers to the use of high frequency generators for non-contact heating of metal using electromagnetic induction. This is accomplished by applying an alternating current to a coil 56, FIG. 6, surrounding the metal. A magnetic field is generated by the current flowing in the coil and induced loss is generated causing heat.
8. Introduce non-oxidizing inert atmosphere (46) to encompass the two surfaces to be joined to minimize oxidation while at temperature.
9. Bring the mating interfaces together with an axial force (48) that is approximately equivalent to the conventional friction welding force. Continue to rotate (spin) the tube (or solid) while applying the axial force until the energy is approximately 10% of the energy for conventional friction welding. At this point, a fully bonded surface is realized.
10. Perform final heat treatment (50) which includes a solution anneal, normalization, and temper to achieve properties.
11. Perform final dimensional machining (52).
12. Perform final NDE (54) of the component including all joined regions between the vessel head and the tubes.

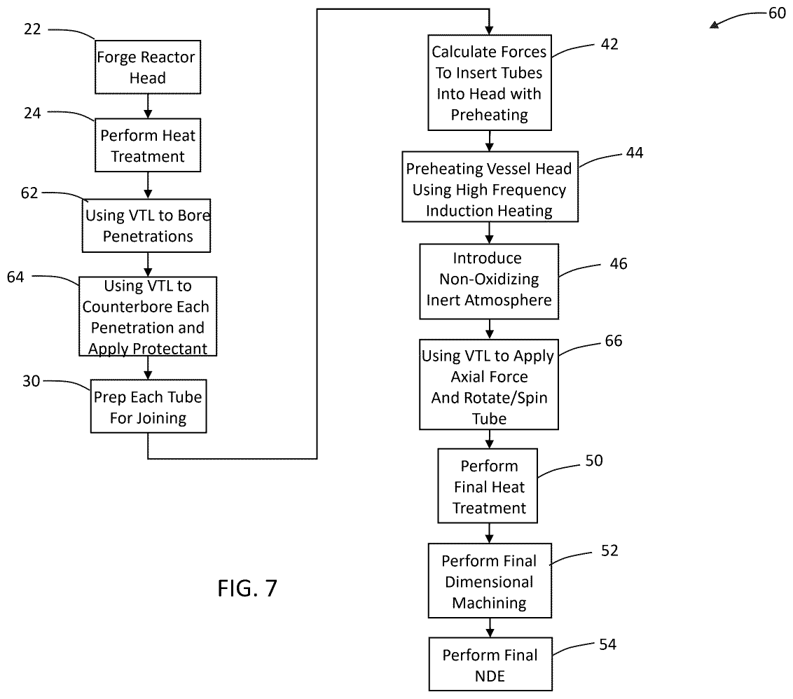

A method 60 of solid-state joining is illustrated in FIG. 7. The method 60 utilizes the same method as method 40 except method 60 employs a vertical turning lathe (VTL) together with a dedicated tool head attachment to generate the high downward axial/rotational forces and torque required to produce the joining of the tube to the RPV head. The method includes the steps of:
1. Forge a reactor head (22) using conventional hot working methodologies similar to those already employed by forging companies today to produce the head, minus the tubes. This essentially results in a dome without penetrations or tubes at this point in the process.
2. Perform heat treatment (24) of the vessel head.
3. Bore the penetrations (26) to accept each of the tubing and/or nozzles (e.g., CRD tubes, inspection tubes, and inspection nozzles) to neat net shape (NNS). Note, this requires precise alignment for each penetration.
4. Counterbore each penetration (28) to accept a tube and/or nozzle and protect the counterbore region with an appropriate protectant to minimize oxidation of the counterbored region. One example of a protectant is COSMOLINE.
5. Prep each tube (30) for joining and protect with an appropriate protectant to minimize oxidation of the tube.
6. Calculate forces (42) necessary to insert tubes (or solid) into vessel head using preheating methods. Forces include but are not limited to downward axial and rotational forces.
7. Preheating (44) should be accomplished with high frequency induction heating (or other viable means) to promote a thin layer of preheated base material sufficient to join a tube (or solid) via a solid-state joining method. As used herein, high frequency induction heating refers to the use of high frequency generators for non-contact heating of metal using electromagnetic induction. This is accomplished by applying an alternating current to a coil 56 surrounding the metal. A magnetic field is generated by the current flowing in the coil and induced loss is generated causing heat.
8. Introduce non-oxidizing inert atmosphere (46) to encompass the two surfaces to be joined to minimize oxidation while at temperature.
9. Using the VTL to bring the mating interfaces together with an axial force (66) that is approximately equivalent to the conventional friction welding force. Continue to rotate (spin) the tube (or solid) while applying the axial force until the energy is approximately 10% of the energy for conventional friction welding. At this point, a fully bonded surface is realized.
10. Perform final heat treatment (50) which includes a solution anneal, normalization, and temper to achieve properties.
11. Perform final dimensional machining (52).
12. Perform final NDE (54) of the component including all joined regions between the vessel head and the tubes.

The advantage of the VTL approach is that it minimizes potential misalignment during boring of the penetrations and during counterboring for acceptance of the tubes through the use of computerized alignment and machining technologies. It also minimizes off-centering (malalignment) of the tubes during the joining process.

All three methods 20, 40, and 60 described above may employ a final heat treatment to remove microstructural evidence of the joined region. The heat treatment would require a solution anneal, normalization, and temper to achieve final properties for a low alloy steel component. It should be appreciated that the above three methods may also be employed for other vessel alloys such as stainless steel, nickel-based alloys, and copper-based alloys.

The advantage of using one of the solid-state integral joining methods described above is the ability to completely eliminate any evidence of the DMWs between the RPV head and the tubes resulting in one monolithic head structure (i.e., no evidence of welds). Current manufacturing (forging and considerable machining) methods may be discouraged for SMRs and ARs in the future as manufacturers look to decrease costs and improve throughput. This methodology has the potential to save 12-18 months in production schedule and millions of dollars for each reactor head.

The foregoing has described a method of manufacturing a monolithic vessel head. All of the features disclosed in this specification, and/or all of the steps of any method or process so disclosed, may be combined in any combination, except combinations where at least some of such features and/or steps are mutually exclusive.

Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends, or to any novel one, or any novel combination, of the steps of any method or process so disclosed.

What is claimed is:

1. A method of manufacturing a monolithic vessel head, comprising the steps of:
forging a vessel head;
boring at least one penetration in the vessel head; and
inserting a tube into the at least one penetration and using a solid-state joining process to join the tube to the vessel head.

2. The method of claim 1, further including the step of heat treating the vessel head after the step of forging.

3. The method of claim 1, further including the step of counterboring the at least one penetration after the step of boring.

4. The method of claim 1 further including the step of calculating forces necessary to insert the tube into the at least one penetration without preheating prior to the step of inserting.

5. The method of claim 4, wherein the step of calculating forces includes the steps of calculating axial and rotational forces.

6. The method of claim 1, wherein the solid-state joining process is a friction hydropillar process.

7. The method of claim 1, further including the step of calculating forces necessary to insert the tube into the at least one penetration with preheating prior to the step of inserting.

8. The method of claim 7, wherein the step of calculating forces includes the steps of calculating axial and rotational forces.

9. The method of claim 1, further including the step of preheating the vessel head using high frequency induction heating prior to the step of inserting.

10. The method of claim 1, wherein the step of inserting further includes the steps of applying an axial force while rotating the tube.

11. The method of claim 1, wherein the step of boring includes the step of using a vertical turning lathe to bore the at least one penetration.

12. The method of claim 1, wherein the step of inserting includes the step of using a vertical turning lathe to apply an axial force and rotate the tube.

13. A method of manufacturing a monolithic vessel head, comprising the steps of:
forging a vessel head;
performing heat treatment on the vessel head;
boring at least one penetration in the vessel head;
counterboring the at least one penetration;
calculating forces necessary to insert a tube into the at least one penetration; and
inserting a tube into the at least penetration and using a solid-state joining process to join the tube to the vessel head.

14. The method of claim 13, wherein the step of calculating forces is calculated with the vessel head preheated.

15. The method of claim 13, wherein the step of boring includes the step of using a vertical turning lathe to bore the at least one penetration.

16. The method of claim 13, wherein the step of inserting includes the step of using a vertical turning lathe to apply an axial force and rotate the tube.
